(19) United States
(12) Patent Application Publication
(10) Pub. No.: US 2024/0394359 A1
(43) Pub. Date: Nov. 28, 2024

(54) Method and Apparatus for Providing A Secure GPU Execution Environment via A Process of Static Validation

(71) Applicant: Visionary Technologies LLC, Belmont, CA (US)

(72) Inventors: Haohui Mai, Belmont, CA (US); Christoforos Kozyrakis, Palo Alto, CA (US)

(73) Assignee: Visionary Technologies LLC, Belmont, CA (US)

(21) Appl. No.: 18/674,713

(22) Filed: May 24, 2024

Related U.S. Application Data
(60) Provisional application No. 63/469,542, filed on May 30, 2023.

(30) Foreign Application Priority Data
May 25, 2023 (CN) 202310599974.5

(51) Int. Cl. G06F 21/53; G06F 21/54

(52) U.S. Cl. CPC G06F 21/53; G06F 21/54

(57) ABSTRACT

A system and process capable of providing a trusted execution environment (“TEE”) for one or more graphic processing units (“GPUs”) include a secure hypervisor, application sandbox virtual machine (VM), secure VM service module (SVSM), and security monitor (SM). In one embodiment, the secure hypervisor is running on a central processing unit (CPU) to regulate all interactions between software stacks and hardware. The application sandbox VM is running on top the hypervisor that hosts applications. The SVSM is running at virtual machine privilege level 0 (VMPLO) in a VM to regulate interactions between the applications and a GPU, wherein the SVSM includes a validator for verifying security and integrity of one or more GPU executions running on the GPU. The SM is configured to regulate interactions between VMs and the GPU in accordance with security properties.

### PRIORITY

This application claims the benefit of priority under 35 U.S.C. § 119 based upon U.S. Provisional Patent Application No. 63/469,542, filed on May 30, 2023, and entitled “Method and Apparatus for A Secure, Efficient GPU Execution Environment with Minimal Trusted Computing Base (TCB),” which is incorporated by reference herein in its entirety.

This application claims the benefit of priority of an earlier filed Chinese patent application Ser. No. 202310599974.5, filed on May 25, 2023 with China National Intellectual Property Administration of the People's Republic of China, the disclosure of which is hereby incorporated by reference.

### FIELD

The exemplary embodiment(s) of the present invention relates to the field of computer hardware and software. More specifically, the exemplary embodiment(s) of the present invention relates to microprocessors.

### BACKGROUND

With increasing popularity of artificial intelligence (AI), autonomous driving, IoT (Internet of Things), robotic controls, digital computations, and/or network communications, there is an increasing demand for fast, flexible, and efficient hardware, such as Graphics Processing Units (GPUs). GPUs, for example, are used to process large models, applications, and/or images during autonomous driving. GPUs can also be deployed as accelerators for generating applications like machine learning and real-time data processing in modern cloud computing systems.

Hardware accelerators and deep neural networks, for example, continue to enable personalized experiences for physical and digital presences, reshaping areas ranging from smart homes, virtual reality, and medical applications. Offering such intimate experiences heavily relies on large amounts of valuable and sensitive user data, which requires high levels of security and privacy support on hardware accelerators such as GPUs. Hardware accelerator or acceleration combines the flexibility of general-purpose processors, such as CPUs, with customized hardware, such as GPUs and ASICs, increasing efficiency when any application is executed in digital computing systems. For example, visualization processes can be offloaded onto a graphics card in order to enable faster, higher-quality playback of videos and games, while also freeing up the CPU to perform other tasks.

The deployment of GPUs has been one of the most ubiquitous accelerators for production applications like machine learning and autonomous driving in modern cloud computing systems. The security features of GPUs in such a public and shared environment, however, becomes vitally important when the processed data are sensitive and expose user privacy.

To process voluminous sensitive data, data integrity and/or security is of critical importance. Various security features of GPU applications in public, private, and/or shared environment becomes vitally important since the processed data can be sensitive as well as user privacy. A conventional approach to enhance GPU security is to use GPU Trusted Execution Environments (TEEs). However, a drawback is that a conventional GPU TEEs requires hardware changes which may cause a long lead time for deploying in production environments.

### SUMMARY

One embodiment of the presently claimed invention discloses a process of providing a trusted execution environment (TEE) for one or more graphic processing units (GPUs) via a TEE platform such as Honeycomb. In one aspect, the process establishes a secure virtual machine (VM) that contain one or more applications. Each VM establishes two virtual machine privilege level (VMPLs). A secure virtual machine service module (SVSM) runs in VMPL0 to regulate all communications between applications and GPUs, one or more applications run in VMPL1. The process is further capable of allocating a sandbox virtual machines (VM) to include a security monitor (SM) for regulate all interactions between drivers and the GPU to improve overall GPU data integrity. In addition, the process of establishing root of trust is established via a hypervisor running at the lowest level, or directly through hardware support.

Additional features and benefits of the exemplary embodiment(s) of the present invention will become apparent from the detailed description, figures and claims set forth below.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a diagram illustrating a system including CPU, GPU, application VM, sandbox VM, and hypervisor for facilitating TEE in accordance with one embodiment of the present invention;

FIG. 2 is a diagram illustrating a source code of GPU application kernel and layout of virtual address spaces in accordance with one embodiment of the present invention;

FIG. 3 is a flowchart illustrating a process of SVSM in accordance with one embodiment of the present invention;

FIG. 4 is a flowchart illustrating a process of validating shared regions in accordance with one embodiment of the present invention;

FIG. 5 is a diagram illustrating a computer network capable of facilitating a TEE for one or more GPUs in accordance with one embodiment of the present invention; and

FIG. 6 is a block diagram illustrating a digital processing system capable of facilitating TEE implemented by Honeycomb in accordance with one embodiment of the present invention.

### DETAILED DESCRIPTION

Embodiments of the present invention are described herein with context of a method and/or apparatus for providing a trusted execution environment (TEE) for a graphic processing units (GPU) via Honeycomb™.

The purpose of the following detailed description is to provide an understanding of one or more embodiments of the present invention. Those of ordinary skills in the art will realize that the following detailed description is illustrative only and is not intended to be in any way limiting. Other embodiments will readily suggest themselves to such skilled persons having the benefit of this disclosure and/or description.

In the interest of clarity, not all of the routine features of the implementations described herein are shown and described. It will, of course, be understood that in the development of any such actual implementation, numerous implementation-specific decisions may be made in order to achieve the developer's specific goals, such as compliance with application- and business-related constraints, and that these specific goals will vary from one implementation to another and from one developer to another. Moreover, it will be understood that such a development effort might be complex and time-consuming but would nevertheless be a routine undertaking of engineering for those of ordinary skills in the art having the benefit of embodiment(s) of this disclosure.

Various embodiments of the present invention illustrated in the drawings may not be drawn to scale. Rather, the dimensions of the various features may be expanded or reduced for clarity. In addition, some of the drawings may be simplified for clarity. Thus, the drawings may not depict all the components of a given apparatus (e.g., device) or method. The same reference indicators will be used throughout the drawings and the following detailed description to refer to the same or like parts.

In accordance with the embodiment(s) of present invention, the components, process steps, and/or data structures described herein may be implemented using various types of operating systems, computing platforms, computer programs, and/or general purpose machines. In addition, those of ordinary skills in the art will recognize that devices of a less general purpose nature, such as hardware devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

The term “system” or “device” is used generically herein to describe any number of components, elements, sub-systems, devices, packet switch elements, packet switches, access switches, routers, networks, computer and/or communication devices or mechanisms, or combinations of components thereof. The term “computer” includes a processor, memory, and buses capable of executing instruction wherein the computer refers to one or a cluster of computers, personal computers, workstations, mainframes, or combinations of computers thereof.

One embodiment of the presently claimed invention discloses a process and/or apparatus capable of providing a TEE for one or more GPUs via a TEE platform such as Honeycomb™. In one aspect, upon establishing a first virtual memory privilege level (VMPL) to include a secure virtual memory service module (SVSM) for managing signal communications between applications and a GPU, a second VMPL is generated to contain one or more applications for running various operations observed by the SVSM. The process is further capable of allocating a sandbox virtual machines (VM) to include a security monitor (SM) for monitoring signal interactions between drivers and the GPU to improve overall GPU data integrity.

The TEE platform, such as Honeycomb™ software, is a platform designed for enforcing security at high fidelity. For example, Honeycomb software or platform can prevent unauthorized accesses of sensitive data, isolate the data and the code for different applications, and attest the authenticity and integrity of the data and the code running on remote hardware.

It should be noted that there are several TEEs that are similar to Honeycomb for offering various features to provide environments of trusted executions and to enforce security within the TEEs. For example, Intel SGX, AMD SEV and AMD Trust Zone technology uses dedicated secure processors to establish trusted execution environments for applications. They can prevent unauthorized access, isolate different applications, and attest the authenticity and integrity of the applications running on top of the hardware.

One embodiment discloses a process of employing Honeycomb capable of providing a software-based, secure, and efficient TEE for GPU computations. Honeycomb, for example, using CPU TEE, a security monitor, and a SVSM ensures that all potential execution on GPUs are validated before actually running them on the hardware. A validated execution, in one example, includes actual GPU kernel in binary code and a corresponding validation proof to show that the runtime behaviors of the kernel are consistent with security policy of Honeycomb. In one aspect, Honeycomb is able to enable two TEE applications to securely exchange clear-text data using shared device memory on GPU.

One aspect of Honeycomb is to leverage static analysis to validate the security of GPU applications at load time. Co-designing with the CPU TEE, as well as adding OS and driver support, Honeycomb is able to remove both OS and driver from the trusted computing base (TCB). Validation also ensures that all applications inside the system are secure with a small TCB, and it establishes a secure approach to exchange data in plaintext via shared device memory on the GPU.

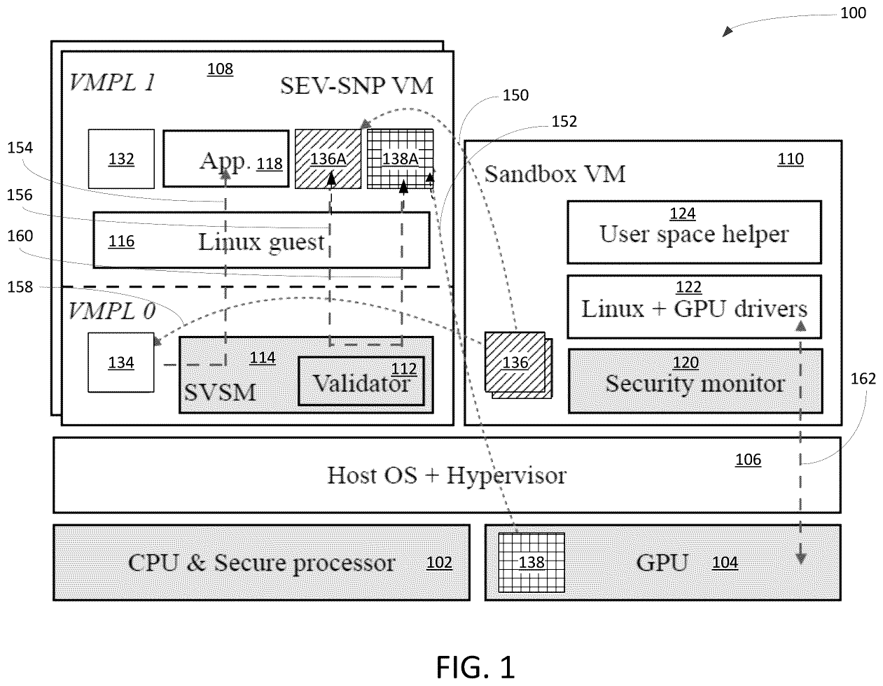

FIG. 1 is a diagram 100 illustrating a system capable of providing a TEE for a GPU via TEE or Honeycomb through static analysis in accordance with one embodiment of the present invention. Diagram 100 includes CPU 102, GPU 104, application VM 108, sandbox VM 110, and hypervisor 106 for facilitating TEE. It should be noted that the underlying concept of the exemplary embodiment(s) of the present invention would not change if one or more blocks (circuit or elements) were added to or removed from diagram 100.

While a CPU is able to perform functions based on execution of instruction, a GPU is considered as a specialized processor designed to accelerate graphics rendering, scientific simulations, and machine learning. A VM (Virtual Machine) is a software-based emulation of a computer. A function of VM is capable of running an operating system and applications just like a physical machine independent from other emulated machines. VM uses isolation of emulated machines permits multiple VMs to run on a single physical machine, each with its own operating system and applications. A hypervisor, which is also known as a virtual machine monitor, can be software, firmware, hardware, or a combination of software, firmware, hardware that facilitates virtual machines (VMs). Hypervisors enable multiple operating systems to share a single hardware host by providing isolated environments for each VM.

Application VM 108 includes VMPL0 and VMPL1 wherein VMPL0 includes SVSM 114, validator 112, and command queue 134. VMPL1 includes SEV-SNP (secure encrypted virtualization-secure nested paging) VM, Linux guest 116, application 118, private memory 132, system memory 136A, and device memory 138A. Command queue 134 stores system memory command queue and private memory 132 stores user data. System memory 136A stores same data or mapped to content of same data in system memory 136 in Sandbox VM 110. Device memory 138A stores same data or mapped to device memory 138 in GPU 104.

Sandbox VM 110 includes a user space helper 124, Linux and GPU drivers 122, security monitor (SM) 120, and system memory 136. In one embodiment, system memory 136 is mapped to system memory 136A in Application VM 108. In addition, the command queue receives data from system memory 136. Note that Hypervisor 106 is employed to manage Application VM 108 and Sandbox VM 110.

Honeycomb, in one embodiment, offers unified TEEs that cover both the CPU and GPU parts of the application. Honeycomb starts an application inside TEE VM such as an AMD SEV-SNP (secure encrypted virtualization-secure nested paging) TEE VM. A Secure VM Service Module (SVSM) 114 is started at VMPL0. The SVSM, for example, bootstraps the BIOS, the guest Linux kernel 116, and finally a user-space application 118 at VMPL1. SVSM 114, in one example, regulates all interactions between the applications and GPU 104. The CPU TEEs data are stored as plaintext within the CPU package. It should be noted that data is encrypted when it leaves for an off-chip main memory. The data stored on device memory of Honeycomb is stored decrypted, and the SVSM 114 encrypts the data when it is sent to a host. The path of reading data is similar.

The application requests GTT memory (system memory) 136 from Honeycomb to interact with the GPU 104. A piece of GTT memory 136 can serve as a staging buffer for memory copies, which is mapped into the user-level address space, or serve as backing buffers for command queues 134, which are accessible by SVSM 114. In one embodiment, the SVSM 114 inspects the access to regulate secure memory transfers between the GPU 104 and the applications 118, and launches validated GPU kernels with proper parameters. Note that although the current implementation of Honeycomb is based on AMD SEV-SNP, our design is applicable to other VM TEEs such as Intel TDX.

Honeycomb is capable of isolating the GPU 104 inside a sandbox VM 110. The security monitor (SM) 120 inside the sandbox is a hypervisor 106 running below the Linux kernel. The SM 120 regulates all interactions between the driver 122 and the GPU 104. It ensures that the GPU 104 follows the expected initialization sequences, and keeps track of the ownerships of the device memory 138A pages to prevent accidental sharing of device memory among applications.

An advantage of using Honeycomb is to provide a secure TEE for GPU execution to enhance data integrity as well as unauthorized tampering without additional hardware support while having a small TCB.

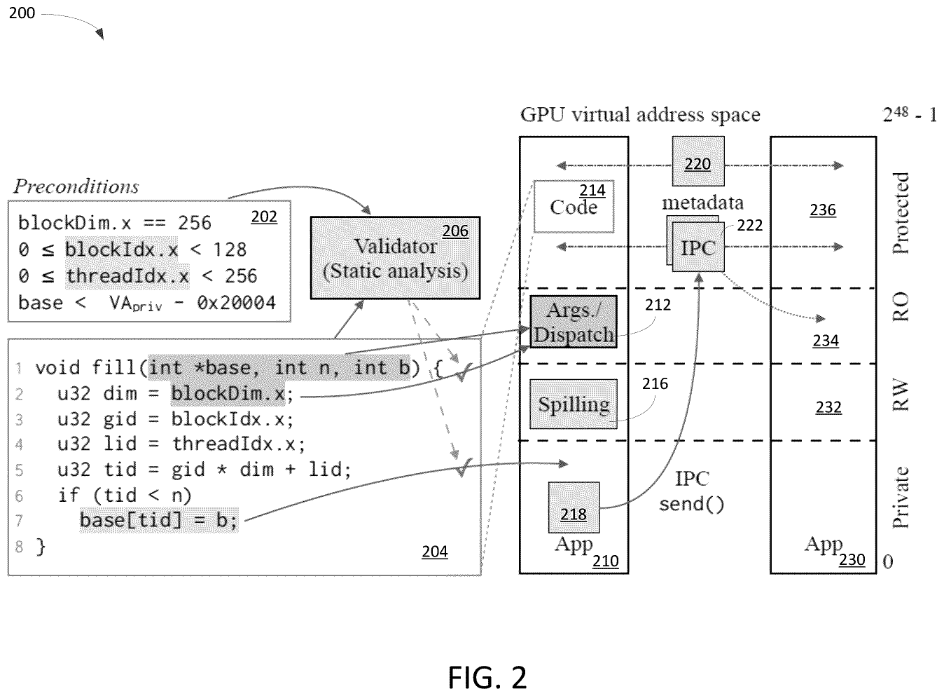

FIG. 2 is a diagram 200 illustrating a process of Honeycomb for providing a secure TEE for GPU execution relating to virtual storage regions in accordance with one embodiment of the present invention. Diagram 200 includes a source code of GPU application kernel 204, validator 206, preconditions 202, and GPU virtual address space 210 and 230. It should be noted that the underlying concept of the exemplary embodiment(s) of the present invention would not change if one or more blocks (circuit or elements) were added to or removed from diagram 200.

In one embodiment, Honeycomb is capable of dividing GPU virtual address space into a protected region 236, read-only region 234, read and write region 232, and private region 230. To execute GPU kernels such as kernel 204, an application first loads the GPU binary that contains the GPU kernels into the device memory 138 or 138A as shown in FIG. 1. The validator 206, which is similar to validator 112 shown in FIG. 1, in Honeycomb takes both the binary code of a GPU kernel and the accompanying preconditions as inputs. The validator 206 validates that each memory instruction in the GPU kernel can access certain regions of the virtual address space 210 or 230. Note that the actual target addresses sometimes cannot be determined until the application executes the kernel with the concrete values of the arguments. In one embodiment, preconditions are introduced, which specify the constraints on the arguments so that the validator 206 can analyze the bounds statically. Honeycomb checks the preconditions 202 at runtime to ensure the attacker or authorized accesses cannot subvert the analysis.

The validator 206, in one embodiment, decodes the instructions of the GPU kernel to reconstruct its control and data flows. Each instruction represents a target address of each memory instruction as a symbolic expression using scalar evolution and polyhedral models. Honeycomb plugs in the preconditions to reason about the bounds of the target address, and ensures that the address stays within specified regions. If the analysis is sound, meaning that once an access is proven, it is safe for all possible executions. For undecided cases like an indirect memory access, Honeycomb requires the developer to annotate and add runtime checks to pass the validation. It should be noted that an evaluation on real-world benchmark suites should show that the overheads of both development and runtime performance are modest-common production GPU kernels like matrix multiplications tend to have regular memory access patterns.

The validator 206 enforces access control that effectively divides the virtual address space of a GPU application into four regions: protected 236, read-only (RO) 234, read-write (RW) 232, and private 230, each of which has different access policies. For example, the application is prohibited to modify the RO region 234, but has full access to the private region 230. Honeycomb places the binary code and the arguments in the RO region 234 so that a malicious kernel cannot modify the code on the fly after passing the validation. Furthermore, Honeycomb implements secure IPC 222 through mapping the buffers 218 into different regions. Honeycomb maps the IPC buffers 222 into the sender's protected 236 and receiver's RO region 234. The sender calls the trusted send ( ) endpoint to copy the plaintext data to the IPC buffer, where both confidentiality and integrity are preserved.

In one embodiment, an apparatus or system capable of providing a TEE for one or more GPUS includes a secure hypervisor, an application sandbox VM, a secure SVSM, and a SM. The secure hypervisor is running on a CPU to regulate all interactions between software stacks and hardware. The application VM which is running on top the hypervisor that hosts applications. The application VM includes SVSM and the application.

The secure SVSM is running at VMPL0 in a VM for regulating interactions between the applications and a GPU, wherein the SVSM includes a validator for verifying security and integrity of one or more GPU executions running on the GPU. It should be noted that CPU is coupled to VMPL0 via the hypervisor and the GPU is coupled to the sandbox VM via the hypervisor. In one example, to enhance data integrity, the SVSM is configured to validate security of GPU kernels of the application.

The SM is configured to regulate interactions between VMs and the GPU in accordance with security properties. The system further includes one or more inter-process communication (IPC) situated inside the TEE and the validator is used to monitor GPU kernels to prevent authorized access to a shared memory region by the IPC. The system is capable of creating a VM environment to establish or host SEV-SNP VM. During an operation, the content stored in a device memory of GPU is mapped at least a portion of information to a virtual device memory situated in VMPL1. The content stored in a system memory in the sandbox VM is mapped to a virtual system memory situated in VMPL1.

The exemplary embodiment of the present invention includes various processing steps, which will be described below. The steps of the embodiment may be embodied in machine or computer-executable instructions. The instructions can be used to cause a general-purpose or special-purpose system, which is programmed with the instructions, to perform the steps of the exemplary embodiment of the present invention. Alternatively, the steps of the exemplary embodiment of the present invention may be performed by specific hardware components that contain hard-wired logic for performing the steps, or by any combination of programmed computer components and custom hardware components.

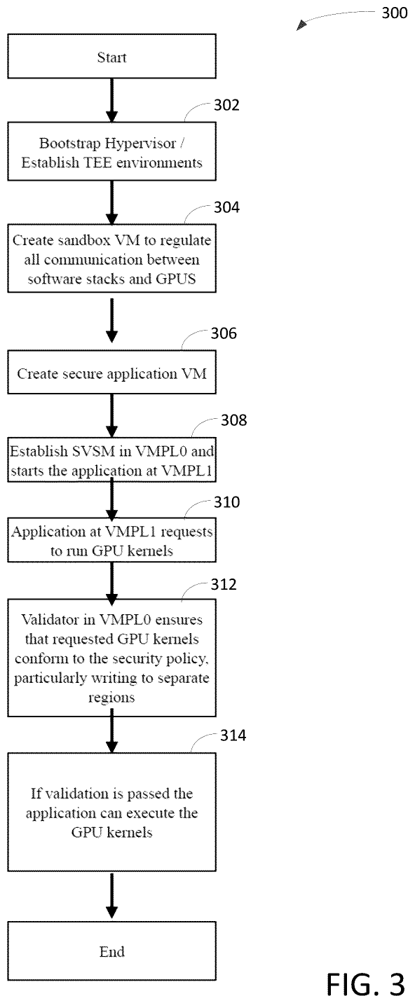

FIG. 3 is a flowchart illustrating a process of SVSM in accordance with one embodiment of the present invention. At block 302, a process capable of providing a TEE for one or more GPUs via a TEE platform such as Honeycomb bootstraps hypervisor for establishing one or more TEE platforms. At block 304, sandbox VM is created to regulate all communications between software stacks and GPUs.

Upon creating a secure application VM at block 306, SVSM at block 308 is established in VMPL0 and the application at VMPL1 starts running. At block 310, the application at VMPL1 requests to run GPU kernels, and validator in VMPL0, at block 312, begins to ensure that requested GPU kernels conform to the security policy, particularly writing to separate regions.

At block 314, the process indicates that if validation is passed, the application can execute the GPU kernels.

In one aspect, upon establishing a first VMPL such as VMPL0 to include a SVSM for managing signal communications between applications and a GPU, creating a second VMPL is created to contain one or more applications for running various operations observed by the SVSM. After allocating a sandbox virtual machines (VM) to include a SM, the SM is used to monitor signal interactions between drivers and the GPU to improve overall GPU data integrity. In one example, the hypervisor is used for managing the first VMPL such as VMPL0, the second VMPL such as VMPL1, and the sandbox VM.

In one embodiment, the system further includes a CPU which is coupled to VMPL0 via the hypervisor. In addition, the sandbox VM is also coupled to GPU managed by hypervisor. It should be noted that an SEV-SNP is established wherein the SEV-SNP further contains one or more VMPLs within VM environment.

VMPL0 further includes a validator which is used to validate accessing regions of virtual address space in accordance with memory instructions in the GPU kernel. It should be noted that at least a portion of stored information in the device memory is mapped to a virtual device memory situated in VMPL1. Also, a portion of information stored a system memory in the sandbox VM is mapped to a virtual system memory situated in VMPL1.

In one embodiment, a process of providing a TEE via Honeycomb is capable of establishing a VMPL1 to include a guest block, an application block, a private memory, a system memory, and a device memory for running various operations observed. VMPL0 is established to include a validator for managing signal communications between applications and a graphic processing unit (GPU). In one aspect, at least a portion of GPU virtual address space is divided to include a protected region, a right-only region, a read-only region, and a private region. The sandbox VM is allocated to include a SM which is used to monitor various signal interactions between drivers and the GPU to improve overall GPU data integrity. Note that hypervisor connects the GPU to the sandbox VM.

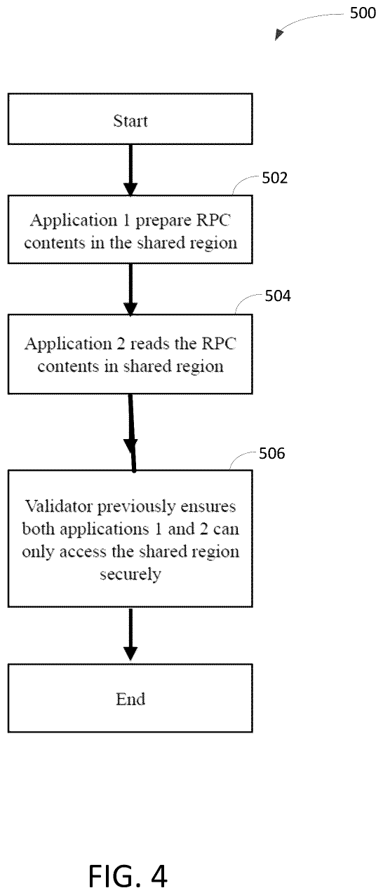

FIG. 4 is a flowchart 500 illustrating a process of validating shared regions in accordance with one embodiment of the present invention. At block 502, application 1 prepares content of remote processing call (RPC) in a shared region. At block 504, application 2 reads the content of RPC in the shared region. At block 506, the validator previously ensures both application 1 and 2 that they can access the shared regions. It should be noted that RPC is a protocol that allows a program to execute a procedure on another address space. A purpose of RPC is to enable communication between distributed systems.

Innovations on hardware accelerators and deep neural networks continue to enable personalized experiences for our physical and digital presences, reshaping areas ranging from smart homes, virtual reality, to personalized cancer medicines. Offering such intimate experiences requires high levels of security and privacy.

Trusted Execution Environment (TEE) is a promising technique to offer both efficient and secure computations at the same time. Recent proposals on GPU TEE allow utilizing hardware accelerators like GPUs in secure computations. The TEE arguments the GPU hardware of the bus controller to create an enclave for the GPU. The GPU inside the enclave computes on clear-text data at native speed. The TEE encrypts the traffic of the enclaves to enforce the data's confidentiality and integrity. Therefore, applications can enjoy the massive computational powers provided by the GPUs and only pay for the performance overheads when crossing the boundaries of enclaves.

Production applications, however, are running on a wide range of legacy GPUs without the proposed hardware changes. Production applications such as autonomous driving are moving from monolithic architectures towards modularized services for better reliability and faster velocity on development. Both issues hinder the real-world deployments of GPU TEEs.

Honeycomb pivots from the conventional practice where a TEE admits arbitrary, untrusted applications and confines their behaviors at runtime. Instead, Honeycomb admits validated executions into the system. The validation is able to demonstrate that all possible executions conform with the security policy of Honeycomb (e.g., it never accesses the secure storage) when loading the GPU applications into the system. The design of Honeycomb shifts the burdens of enforcing security from run time to load time.

With validated execution, Honeycomb enables two TEE applications to securely exchange clear-text data using shared device memory on GPU (Section 7). The fast path opens up opportunities to low-latency transfer and adopting modularized architectures for GPU applications. A validated execution in Honeycomb includes actual GPU kernel in binary code and a corresponding validation proof. The validation proof implements a form of lightweight Software Fault Isolation (SFI) for GPU programs. A validation proof is the result of program analysis showing that (1) the GPU kernel can follow its own control flows or make calls to a set of predefined entry points for service routines, and (2) all potential memory accesses only access their corresponding subrange of the address space, provided certain pre-conditions are met. Honeycomb checks the pre-conditions right before launching the kernel.

Modern GPUs offer the single instruction, multiple thread (SIMT) programming model to the applications. To run a workload, an application submits a launch request to the command queue of the GPU. The request specifies the binary function (i.e., GPU kernel), its arguments, the number of threads, and optionally the size of a user-controllable, on-die high-speed scratch pad (i.e., shared memory) to perform the workload. Note that the threads are organized into grids and blocks uniformly. Each grid consists of the same number of blocks, and each block consists of the same number of threads. Each thread within the same block has its own vector registers but shares access to the shared memory. The programming model provides a conceptual view where each thread executes the same instruction based on the values of its own registers. Application loading different data into each thread to parallelize the workloads.

The hardware architecture of GPUs closely matches the SIMT model above. A typical GPU consists of thousands of processing elements (PE) that are grouped into a three-level hierarchy. The lowest level is called a warp, consisting of 32 or 64 logical PEs executed in lock-step. The architecture might introduce parallel scalar units to perform uniform computation within a warp, or pipeline the computations on physical PEs to hide execution latency (e.g., the AMD GCN architecture). The warps are further grouped into Compute Units (CU) or Streaming Multiprocessors. A CU consists of a pool of vector registers and shared memory. Finally, a single GPU packages multiple CUs on the same die.

The hardware scheduler multiplexes the hardware resources across applications. The minimal scheduling unit is a warp. The scheduler restores the values of vector registers when swapping warps. Note that the scheduler always schedules all warps of a block within the same CU. Therefore, all threads within a block divide the vector register pool of the CU, all of which can access the same allocated shared memory inside the CU. The scheduler continuously schedules all the blocks and grids until the execution is completed.

Current GPU drivers create a virtual address space for each GPU application. The driver allocates buffers for arguments and the command queues out of the Graphics Translation Table (GTT) memory from the host and maps them into the virtual address space on the GPU, so that launching a GPU kernel becomes a pure user space operation. As a result, the GPU kernel reads the values of the arguments and the layout of threads directly from the buffers.

AMD SEV-SNP (Secure Nested Paging) is a secure execution technique on AMD processors that offer enhanced security features at the hardware level for Virtual Machines (VMs) running on an untrusted cloud system hypervisor. Similar to other TEEs, SEV-SNP supports remote attestation as well as both data confidentiality and integrity guarantees for the application VMs against malicious host hypervisors. A dedicated hardware engine in the memory controller encrypts data before sending them to the off-chip main memory. SEV-SNP also tracks the ownership of each physical page with a Reverse Map Table (RMP) so that only the owner can write to a memory region. It further validates the page mapping to prevent malicious re-mapping of a single page to multiple owners. In such ways, it is able to alleviate typical data corruption, replay, memory aliasing, and memory re-mapping attacks.

In addition, SEV-SNP further offers additional flexibility in the form of multiple Virtual Memory Privilege Levels (VMPLs). Essentially, the VM address space is divided into four levels, from the highest privileged VMPL0 to the least VMPL3. The RMP entry of each physical page is augmented with this VMPL permission information. Each process in the VM can be assigned a VMPL, and granted access to the pages with sufficient privilege. This feature enables additional control within a VM. SEV-SNP is currently limited to CPU TEEs.

Polyhedral model has been widely used in automatic parallelization and optimizing GPU programs. Conceptually it represents each memory access as an affine expression over an ordered set of loop variables. Since an affine expression is a linear combination of base variables, analyzing the effects of memory access, such as aliasing and ranges, reduces to solving inequalities of integer variables. The polyhedral model works with GPU kernels well because GPU kernels implicitly loop over the grids and the blocks, and performant GPU kernels have regular memory access patterns.

More concretely, an iteration vector [symbol] =(i₀,i₁, . . . ,iₙ)∈ [symbol] ^{s} records the value of loop induction variables i₀, . . . , iₙ for an instruction s. The domain [symbol] ^{s} is called the iteration domain. Note that the iterator vector usually includes the grid index (gid) and the local thread index (lid) for instructions in GPU kernels. An access function [symbol] takes an iterator vector as input and outputs the actual memory address.

Note that [symbol] ^{s} is an affine function and [symbol] ^{s} is an affine space, that is, all loops in [symbol] have fixed steps. For simplicity, we denote an access function as a vector with each element representing the coefficients of the corresponding dimension of the iteration vector. The dot product of the access function and the iteration vector is the actual memory address. We also introduce an extra dimension which always has the value 1 at the end of the iteration vector so that the access function can represent constant offsets in a uniform way.

The GPU command queue is backed by system memory. Honeycomb requires the integrity of the command queue and MMIO of the GPU. Otherwise, a malicious hypervisor can insert requests of memory copy to transfer private data out of the TEE. It is possible to raise the bar of such attacks via setting up the SEV-SNP RMP tables to deny the access to the command queue for hypervisor. Alternatively, Honeycomb can leverage the encrypted command queues provided by other GPU TEEs to remove this assumption. Other than these, we allow the adversary to control all other hardware and software in the system. For example, the adversary can control the hypervisor on the host machine and the GPU device driver.

Four principles guide our designs of Honeycomb:

1. Minimizing the trust to the platform providers is essential to migrate security-critical workloads to the cloud. Honeycomb launches the applications using the commodity available AMD SEV-SNP TEE. Honeycomb currently uses a security monitor to implement a software-only TEE for GPU. Honeycomb can further remove the whole GPU stack from its TCB when existing GPU TEE solutions become generally available.

2. Many GPU applications such as machine learning inference services, are performance-sensitive. Moving security checks from run-time to load time eliminates most overheads from security guarantees.

3. Honeycomb should enable applications to exchange data that are on the device memory without passing them to the host. Shorter data flows not only reduce the attack surfaces, but also open up opportunities to implement emerging solutions like RDMA support and GPU direct storage.

4. Honeycomb focuses on accepting commonly used patterns in real-world applications, which are easy to validate and do not require complex program analysis. Other patterns such as long divisions, nested branches, and indirect memory references could be tricky. Supporting them may enlarge the TCB.

In Honeycomb, all applications are Virtual Machines (VMs) on top of an untrusted hypervisor, and are protected by the AMD SEV-SNP technique; essentially, each application VM becomes an enclave. Each VM contains a trusted security monitor (SM) running at a higher privilege level and intercepts all accesses to the GPU. A key design goal of Honeycomb is to remove the OS kernel and the original GPU driver from the TCB. Similar to existing GPU TEEs, Honeycomb implements the following functionalities.

Honeycomb changes the workflow of launching GPU kernels to enforce security. The application in a VM prepares the arguments, and initiates a load ( ) call to the SM to request a kernel launch. It submits the kernel together with its accompanying validation. The validation also contains a set of pre-conditions that is satisfied to make the validation correct. For example, the GPU kernel might take a pointer as an argument, whose value is not known at static analysis. The validation can then contain a pre-condition that bounds the range of the pointer, so that no loads and stores in the GPU kernel can reach the protected regions. Provided that both the pre-conditions are satisfied and the validations are correct, Honeycomb ensures the application can only access allowed memory regions. Kernels running on the GPU compute units can then directly access the device memory with no extra runtime overheads, improving performance.

Honeycomb ensures address space isolation between different applications. On the CPU side, this is guaranteed by SEV-SNP, which ensures the integrity of VM data and protects against various vulnerabilities including replay and re-mapping attacks. On the GPU side, if TEE solutions are available, such isolation is straightforward. For example, Graviton maintained a reversed page table to verify page ownership, and exposed a new set of API for allocation, deallocation, and sharing. Alternatively, Honeycomb also works with commodity GPUs without mature TEE support, at the cost of tracking and enforcing page ownership at the GPU runtime software level, which enlarges the TCB.

Honeycomb ensures that a GPU kernel from the application passes the validation before being written to the code segment of the address space. Recall that Honeycomb partitions the virtual address space of the application into different regions. The code segment resides in the Hidden region and it remains read-only throughout the lifetime of the application.

Honeycomb implements secure data communication channels between the GPU and the host CPU, and coordinates all data transfers into and out of the GPU device memory. All transfers between the host and the device memory is done via a special trusted kernel in Honeycomb, with all transferred data encrypted and authenticated under an ephemeral encryption key. Honeycomb disallows the applications to map host memory into its address space, or to directly create DMA queues.

One practical issue is how to bootstrap and maintain the secure channel. Honeycomb uses the s_memrealtime instruction to get the value of the real-time counter on the AMD 6900XT GPU. Honeycomb issues a kernel to perform reads, invalidating caches to generate entropy and extracts them. The encrypt is used to establish a shared security key using Diffie-Hellman key exchange. Honeycomb stores the entropy in the Hidden region to prevent user applications from accessing it.

The validator in Honeycomb checks the binary code for each GPU kernel of the application conforms with the following security invariants:
No dangling accesses. A GPU kernel never reads uninitialized values from hardware registers.
All memory accesses reside in their regions. All memory accesses to the memory regions conform with their access policies respectively.
Control flow integrity. The execution of the GPU kernel maintains control flow integrity. It starts at the entry point of the kernel. The kernel can only transfer its control to the entry point of its basic blocks, or to the pre-defined sets of service routines.

The validator starts out parsing the binary of the GPU kernel image and building the Static Single-Assignment (SSA) representation and the Control Flow Graph (CFG) for each kernel function. The validator checks dangling accesses by inspecting whether the SSA representation of the kernel function is valid.

Honeycomb is able to enforce isolation between different applications as long as all memory accesses respect the layout of the virtual address space. The layout simplifies the design and implementation of the secure memory transfer and direct data exchange.

Honeycomb reasons about the coarse-grained memory regions instead of the precise bounds for each memory access, which requires nontrivial analysis, additional runtime support, or annotations on language-level semantics. Honeycomb is able to adopt a simple design and implementation that ensures the address of each load and store instruction falls into the corresponding range, resulting in a smaller TCB.

Honeycomb validates that all branches jump to valid instructions. It also recognizes the instruction sequences that invokes the service routines and validates the targets the target.

Honeycomb allows applications to set up channels to exchange data directly with each other. A channel in Honeycomb is a shared 32 KB lock-free queue backed by the device memory. Honeycomb arranges the channels in specific memory layouts as the following. Honeycomb partitions the address space of each GPU application into four regions: the hidden region, the read-only (RO) region, the read-write (RW) region, and the private region.

For a channel and a particular application, Honeycomb may choose to map it into the RO/RW region because the application can receive or send over the channel, or not to map it in if the application is not given the access. Each application allocates a scratch buffer inside its own RW region where other applications may access via the read ( ) and write ( ) service call which we describe in the later of this section. An application cannot access others' Private region. Honeycomb also maps its internal data structures into the hidden region across all GPU applications.

The virtual addresses of the channel and the scratch buffer are determined only by their ID. Application is able to directly compute the virtual addresses of RPC channels and other's scratch buffers based on the ID without a directory. The validator ensures that all memory accesses of the application conform with the corresponding policy, meaning that an application knowing the addresses still cannot access the sensitive data even though the pages are mapped in.

Note that utilizing the permission control of hardware page tables might be insufficient to enforce security. Particularly, the HSA ABI used by AMD GPU implicitly requires mapping the command queue into the GPU address space so that it is possible to synchronize or to enqueue directly from the GPU kernel.

In one example, an attacker might try to subvert the integrity of the executions by altering the trusted components like the security monitor in Honeycomb. This is ineffective since SEV-SNP includes attestation procedures to verify the trusted software in the VMs. Similarly, altering the GPU firmware, or diverting from the designated bootup sequence is also ineffective as Honeycomb validates both signatures of the firmware and the bootup sequences during GPU initialization. Honeycomb also attests the GPU TEE or validates the trusted runtime software on the GPU (e.g., the page server).

Honeycomb requires developers or users to develop the validation proofs along with the applications. This alternative development model requires a fine balance among the development effort, the capabilities of the validator and the size of TCB. In this section we report our experience on porting the SPEC ACCEL 1.2 benchmark suites and the inference application of the ResNet18 neural network (ResNet18 for short) in order to explore the design spectrums.

As GPUs are increasingly used as the prominent accelerators for machine learning and other data processing applications, recent research has considered extending the protection of TEEs from CPUs to GPUs. Graviton made hardware modifications to the GPU and leveraged the internal command processor to inspect all resource allocation requests to ensure isolation. It also assumes the GPU device memory is integrated in the same package and thus free from snooping and tampering. This avoids the needs of encryption and authentication for all off-chip data accesses. In contrast, HIX avoided hardware changes to the GPU device, but instead relied on a trusted GPU driver to properly isolate and protect applications. This trusted driver component is separated from the OS and relocated into another process running in its own TEE on the host CPU. It still needed to slightly modify the PCle interconnects to ensure reliable data and command routing. As discussed in Section 1, Honeycomb differs from these related proposals in the aspects that it requires no hardware changes, and the complex driver is completely out of the TCB. Honeycomb also addresses attacks that were not covered by previous work.

HETEE took a different approach and used tamper-resistant boxes that consisted of commodity GPUs. A rack of servers can access such secure accelerator boxes via a centralized FPGA-based controller. Telekine was built upon Graviton with API remoting techniques. It specifically addressed a side-channel vulnerability regarding GPU kernel execution timing in the context of machine learning training. Visor focused on privacy-preserving video analytics on the cloud with the help of a hybrid TEE spanning both CPU and GPU, and also addressed several side-channel attacks.

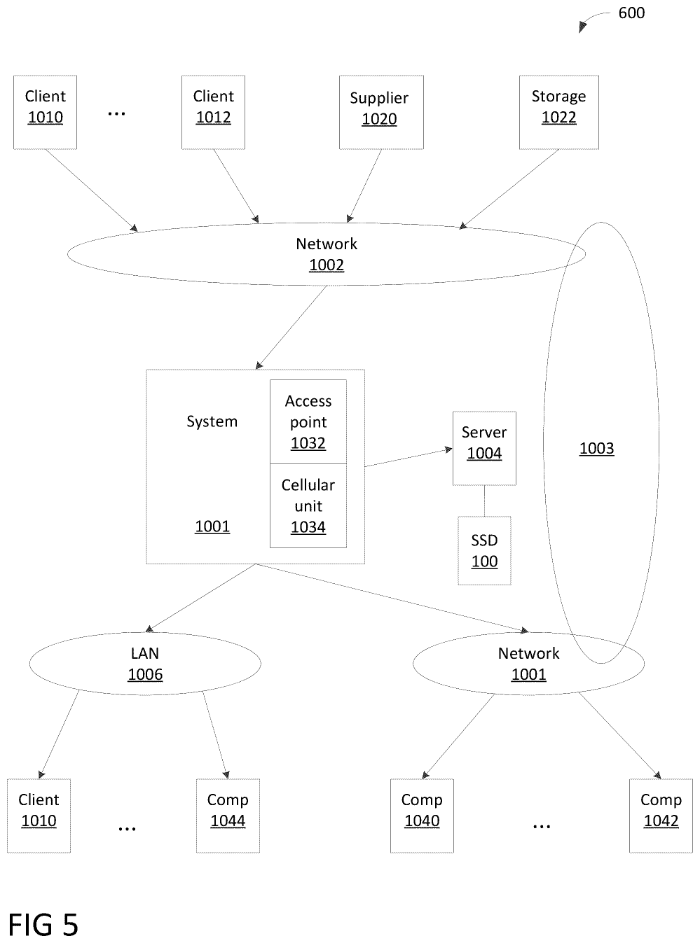

FIG. 5 is a diagram illustrating a computer network capable of facilitating a TEE for one or more GPUs in accordance with one embodiment of the present invention. In this network environment, a system 600 is coupled to a wide-area network 1002, LAN 1006, format conversion Network 1001, and server 1004. Wide-area network 1002 includes the Internet, or other proprietary networks including America On-Line™, SBC™, Microsoft Network™, and Prodigy™. Wide-area network 1002 may further include network backbones, long-haul telephone lines, Internet service providers, various levels of network routers, and other means for routing data between computers.

Server 1004 is coupled to wide-area network 1002 and is, in one aspect, used to route data to clients 1010-1012 through a local-area network (LAN) 1006. Server 1004 is coupled to SSD 100 wherein the storage controller is able to decommission or logically remove defective page(s) from a block to enhance overall memory efficiency.

The LAN connection allows client systems 1010-1012 to communicate with each other through LAN 1006. Using conventional network protocols, USB portable system 1030 may communicate through wide-area network 1002 to client computer systems 1010-1012, supplier system 1020 and storage device 1022. For example, client system 1010 is connected directly to wide-area network 1002 through direct or dial-up telephone or other network transmission lines. Alternatively, clients 1010-1012 may be connected through wide-area network 1002 using a modem pool.

Having briefly described one embodiment of the computer network in which the embodiment(s) of the present invention operates, FIG. 5 illustrates an example of a computer system, which can be a host, a server, a router, a switch, a node, a hub, a wireless device, or a computer system.

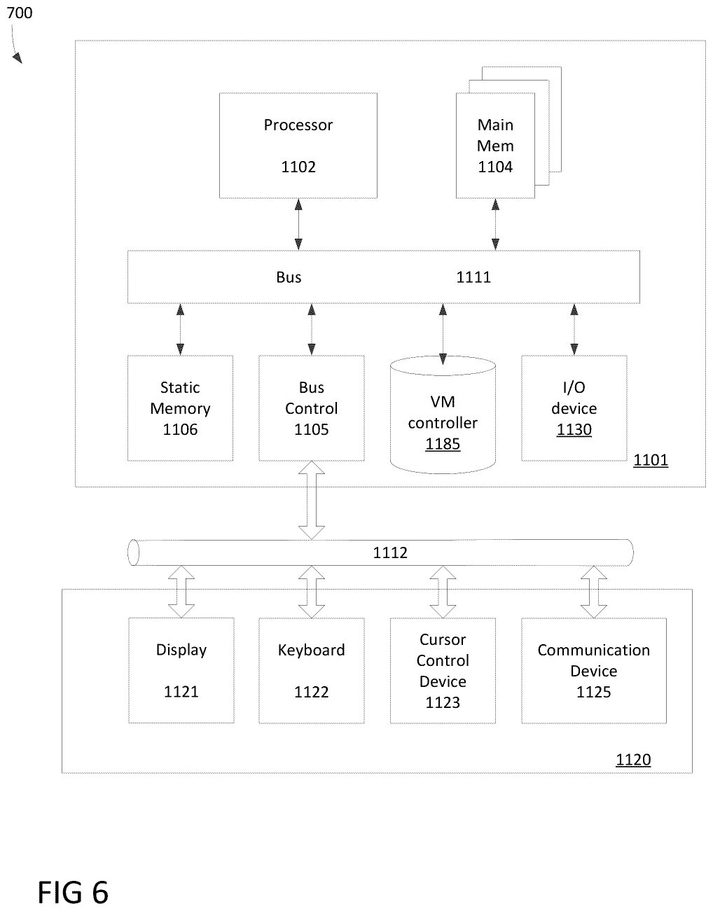

FIG. 6 is a block diagram illustrating a digital processing system capable of facilitating TEE implemented by Honeycomb in accordance with one embodiment of the present invention. Computer system or a signal separation system 700 can include a processing unit 1101, an interface bus 1112, and an input/output (IO) unit 1120. Processing unit 1101 includes a processor 1102, a main memory 1104, a system bus 1111, a static memory device 1106, a bus control unit 1105, an I/O element 1130, and a VM controller 1185. It should be noted that the underlying concept of the exemplary embodiment(s) of the present invention would not change if one or more blocks (circuit or elements) were added to or removed from FIG. 6.

Bus 1111 is used to transmit information between various components and processor 1102 for data processing. Processor 1102 may be any of a wide variety of general-purpose processors, embedded processors, or microprocessors such as ARM® embedded processors, Intel® Core™ Duo, Core™ Quad, Xeon®, Pentium™ microprocessor, Motorola™ 68040, AMD® family processors, or Power PC™ microprocessor.

Main memory 1104, which may include multiple levels of cache memories, stores frequently used data and instructions. Main memory 1104 may be RAM (random access memory), MRAM (magnetic RAM), or flash memory. Static memory 1106 may be a ROM (read-only memory), which is coupled to bus 1111, for storing static information and/or instructions. Bus control unit 1105 is coupled to buses 1111-1112 and controls which component, such as main memory 1104 or processor 1102, can use the bus. Bus control unit 1105 manages the communications between bus 1111 and bus 1112. Mass storage memory or SSD, which may be a magnetic disk, an optical disk, hard disk drive, floppy disk, CD-ROM, and/or flash memories are used for storing large amounts of data. VM controller 1185 is used to facilitate applications of virtual machine (VM).

I/O unit 1120, in one embodiment, includes a display 1121, keyboard 1122, cursor control device 1123, and communication device 1125. Display device 1121 may be a liquid crystal device, cathode ray tube (CRT), touch-screen display, or other suitable display device. Display 1121 projects or displays images of a graphical planning board. Keyboard 1122 may be a conventional alphanumeric input device for communicating information between computer system 1100 and computer operator(s). Another type of user input device is cursor control device 1123, such as a conventional mouse, touch mouse, trackball, or other type of cursor for communicating information between system 1100 and user(s).

Communication device 1125 is coupled to bus 1111 for accessing information from remote computers or servers, such as server or other computers, through wide-area network. Communication device 1125 may include a modem or a network interface device, or other similar devices that facilitate communication between computer 1100 and the network. Computer system 700 may be coupled to a number of servers 1004 via a network infrastructure such as the infrastructure illustrated in FIG. 5.

While particular embodiments of the present invention have been shown and described, it will be obvious to those of ordinary skills in the art that based upon the teachings herein, changes and modifications may be made without departing from this exemplary embodiment(s) of the present invention and its broader aspects. Therefore, the appended claims are intended to encompass within their scope all such changes and modifications as are within the true spirit and scope of this exemplary embodiment(s) of the present invention.

What is claimed is:

1. An apparatus for providing a trusted execution environment (“TEE”) for one or more graphic processing units (“GPUs”), comprising:
a secure hypervisor running on a central processing unit (CPU) to regulate all interactions between software stacks and hardware;
an application sandbox virtual machine (VM) running on top the hypervisor that hosts one or more applications;
a secure virtual memory service module (SVSM) running at virtual machine privilege level 0 (VMPL0) in a VM to regulate interactions between the applications and a GPU, wherein the SVSM includes a validator for verifying security and integrity of one or more GPU executions running on the GPU; and
a security monitor (SM) configured to regulate interactions between VMs and the GPU in accordance with security properties.

2. The apparatus of claim 1, further comprising one or more inter-process communication (IPC) situated inside the TEE, wherein the validator monitors GPU kernels to prevent unauthorized access to a shared memory region by the IPC.

3. The apparatus of claim 1, wherein the application VM includes the SVSM and the application.

4. The apparatus of claim 1, wherein the CPU is coupled to the VMPL0 via the hypervisor.

5. The apparatus of claim 1, wherein the GPU is coupled to the sandbox VM via the hypervisor.

6. The apparatus of claim 1, further comprising a VM environment configured to establish a secure encrypted virtualization secure nested paging (“SEV-SNP”) VM containing one or more VMPLs.

7. The apparatus of claim 1, wherein the SVSM is configured to validate security of GPU kernels of the application.

8. The apparatus of claim 1, further comprising a device memory of the GPU configured to store information which is mapped at least a portion of information to a virtual device memory situated in a second VMPL.

9. The apparatus of claim 1, further comprising a system memory in the sandbox VM configured to store information in which at least a portion of its information is mapped to a virtual system memory situated in a second VMPL.

10. A method for providing a trusted execution environment (TEE) platform, comprising:
establishing a virtual memory privilege level 1 (VMPL1) to include a guest block, an application block, a private memory, a system memory, and a device memory for running various operations observed; and
establishing a virtual memory privilege level 0 (VMPL0) to include creating a validator for managing signal communications between applications and a graphic processing unit (GPU), wherein the creating a validator includes dividing at least a portion of GPU virtual address space to a protected region, a right-only region, a read-only region, and a private region.

11. The method of claim 10, further comprising allocating a sandbox virtual machines (VM) to include a security monitor (SM) for monitoring signal interactions between drivers and the GPU to improve overall GPU data integrity.

12. The method of claim 11, further comprising coupling the GPU to the sandbox VM via a hypervisor.

13. The method of claim 10, further comprising providing a layer of hypervisor for managing the VMPL0, the second VMPL1.

14. The method of claim 10, further comprising coupling a central processing unit (CPU) to the VMPL0 via a hypervisor.

15. The method of claim 10, further comprising creating a secure virtual memory service module (SVSM) in the VMPL0 for facilitating interactions between applications and the GPU.

16. An apparatus for providing a trusted execution environment (TEE) for one or more graphic processing units (GPUs), comprising:
means for establishing a first virtual memory privilege level (VMPL) to include a secure virtual memory service module (SVSM) for managing signal communications between applications and a GPU;
means for creating a second VMPL to contain one or more applications for running various operations observed by the SVSM; and
means for allocating a sandbox virtual machines (VM) to include a security monitor (SM) for monitoring signal interactions between drivers and the GPU to improve overall GPU data integrity.

17. The apparatus of claim 16, further comprising means for providing a layer of hypervisor for managing the first VMPL, the second VMPL, and the sandbox VM.

18. The apparatus of claim 16, further comprising:
means for coupling a central processing unit (CPU) to the first VMPL via a hypervisor; and
means for coupling the GPU to the sandbox VM via a hypervisor.

19. The apparatus of claim 16, further comprising means for establishing a secure encrypted virtualization secure nested paging (SEV-SNP) containing one or more VMPLs through a VM environment.

20. The apparatus of claim 16, wherein means for establishing a first VMPL includes means for generating a validator for validating accessing regions of virtual address space in accordance with memory instructions in the GPU kernel.
